(19) United States
(12) Patent Application Publication
(10) Pub. No.: US 2003/0113531 A1
(43) Pub. Date: Jun. 19, 2003

(54) Conductive fillers and conductive polymers made therefrom

(76) Inventors: Karel Hajmrle, Fort Saskatchewan (CA); Brian William Callen, Fort Saskatchewan (CA); Jim K. Mah, Edmonton (CA)

Correspondence Address: GOWLING LAFLEUR HENDERSON LLP, COMMERCE COURT WEST, SUITE 4900, TORONTO, ON, M5L 1J3, CA

(21) Appl. No.: 10/020,884

(22) Filed: Dec. 19, 2001

(51) Int. Cl. B05D 1/12; B32B 5/16

(52) U.S. Cl. 428/327; 427/180

(57) ABSTRACT

A particulate conductive filler which comprises a particulate elastomer polymer core having a conductive metal coating thereon. The conductive filler is uniformly dispersed in an elastomer polymer matrix to form composite materials for conductive applications.

### BACKGROUND OF THE INVENTION

(i) Field of the Invention

The present invention relates to a particulate conductive filler used in the preparation of conductive polymer compositions for application in the manufacture of electronic components and the like and, more particularly, relates to a particulate elastomer polymer core having a conductive metal coating thereon uniformly dispersed in an elastomer polymer matrix.

(ii) Description of the Related Art

Conventional shielding products are used in electronic applications ranging from aerospace components to cellular telephones to provide protection from electromagnetic interference (EMI) and radio frequency interference (RFI). Typically, such shielding products were formed by the introduction of a conductive filler into a polymeric matrix based on the premise that reduced volume resistance (DC resistance) translates to an increase in shielding effectiveness. The trade journal article Interference Technology Engineers' Master ITEM 1999 “Correlating DC Resistance to the Shielding Effectiveness of an EMI Gasket” Thomas Clupper p. 59 produces theoretical models that relate shielding effectiveness to resistance. The EMI shielding effectiveness of two gasket materials and DC resistance across each gasket were measured while each gasket was mounted in a fixture. A resistance of 1 ohm was measured across the fixture for gasket A and 0.01 ohm was measured for gasket B. The EMI shielding effectiveness of gaskets A and B were measured at 65 dB and 42 dB respectively at 100 MHz, showing an increase in shielding effectiveness with reduced volume resistivity.

Initially, the conductive fillers were composed of solid noble metal particles. However, such fillers are extremely costly and attempts were made to develop more economic conductive fillers without the loss of shielding and conductivity properties. Less costly alternative materials consist of noble metals clad on comparatively inexpensive core materials such as glass, aluminum or copper. The use of noble metals is considered too costly for some applications. Subsequently, copper and nickel powders were used for this purpose, followed by the use of nickel clad graphite or carbon core particles.

In U.S. Pat. No. 5,284,888, there is disclosed an EMI/RFI shielding composition which comprises a polyurethane resin formed of two polymers having a stabilized conductive filler therein and an azole. The preferred filler is a silver stabilized copper powder.

Kalinoski et al. U.S. Pat. No. 6,096,413 describes a conductive gasket formed of silicone urethane and/or thermoplastic block copolymers having a conductive filler associated therewith. The conductive fillers used to fill the elastomers can be selected from pure silver, noble metal-plated non-noble metals such as silver plated copper, nickel or aluminum. Non-noble metal-based materials including non-noble metal-plated non-noble metals are also suitable, exemplary of which would be copper-coated iron particles. In addition, non-metal materials such as carbon black and graphite and combinations thereof may be used.

An EMI shielding gasket using nickel coated graphite particles with EMI shielding effectiveness of at least 80 dB between 10 MHz and 10 GHz is described by Kalinoski in U.S. Pat. No. 5,910,524. The volume resistivity of this material is reported to be from about 500-1000 milliohm-cm.

U.S. Pat. No. 4,795,660 discloses electrically conductive films comprised of intermetallic compounds incorporated into a thermosetting polymer composition. U.S. Pat. No. 4,911,981 discloses tubular, spheroidal and helical lipid microstructures clad with a metal coat deposited thereon by an electroless plating bath. The microstructures are embedded in a polymer matrix such as an epoxy or polyurethane to form a composite material having electrical conductivity. U.S. Pat. No. 4,098,945 discloses a soft, conformable, conductive composition comprising soft, deformable spheres and a filler of conductive particles dispersed adjacent each other in a matrix of a polymeric binder.

The essential feature of this invention is to clad an elastomer material such as silicone rubber with nickel or another metallic material and then incorporate it into an elastomer matrix (e.g. silicone rubber) rendering it conductive. Typical example: silicone rubber particles clad with nickel and then incorporated into a silicone rubber matrix rendering it conductive. The essential feature of this invention is an elastomeric material that can be made conductive by what is essentially a thin network of metal throughout the matrix. This invention can be produced by methods that are well known in the art. The density of the conductive material so produced is lower than that of conductive elastomers that use conventional lightweight fillers. Such conventional lightweight fillers have core materials such as graphite, aluminum, or solid glass spheres that are more dense than polymers. Other conventional lightweight core materials such as glass bubbles have the disadvantage of being brittle or friable and easily break during processing.

### SUMMARY OF THE INVENTION

It is a principal object of the present invention to provide a particulate conductive filler comprised of a metal coating over an elastomer polymer core. The particulate conductive filler is combined with an elastomer polymer matrix to produce a low density composite material from which desired components may be manufactured.

It is an another object of the invention to provide a composite material exhibiting improved EMI shielding and electrical conductivity properties.

In accordance with the invention there is provided a particulate conductive filler for use with a elastomer polymer matrix to form composite materials wherein each particle comprises a particulate elastomer core having a conductive metal coating.

The invention further extends to a composite material comprising; an elastomer polymer matrix having a filler therein of particles formed of an elastomer polymer core having a conductive metal coating thereon. The elastic polymer matrix may be selected from any single or combination of natural rubbers and synthetic elastomers including hydrocarbon rubbers (EPM, EPDM, butyl and the like), nitrites, polychloroprenes, acrylic, fluoro- and chlorosulfonated polyethylenes, polymethanes, polyethers, polysulfides, nitrosorubbers, silicones and fluorosilicones. The particulate elastomer core maybe selected from any single or combination of natural rubbers and synthetic rubbers including hydrocarbon rubbers (EPM, EPDM, butyl and the like), nitrites, polychloroprenes, acrylic, fluoro- and chlorosulfonated polyethylenes, polyurethanes, polyethers, polysulfides, nitrosorubbers, silicones and fluorosilicones. Preferably, said elastomer polymer matrix is silicone elastomer and said particulate elastomer core is silicone elastomer. The conductive metal coating is selected from the group consisting of nickel, copper, aluminum, tin, cobalt, zinc, gold, silver, platinum, palladium, rhodium, iridium and their alloys. The coating may consist of a single metal or a combination of metals. The preferred conductive metal coatings are nickel, or silver deposited on the nickel coating, or gold deposited on the nickel coating. The conductive metal coating comprises about 20 to 90 wt % of the coated particle, preferably about 30 to 80 wt % of the coated particle.

The particulate elastomer polymer core is between about 1 and 300 microns in size, preferably the particulate elastomer core being between about 20 and 200 microns in size. The particulate conductive filler is present in an amount of up to 80 wt % preferably about 50 to 70 wt % of the composite material.

The density of elastomer core materials are typically lower than that of core materials used in prior art. Silicones and natural rubber densities typically range from ˜0.9 g/cm³ to ˜1.1 g/cm³, whereas conventional light-weight core materials such as solid glass and graphite are typically ˜2.5 g/cm³ and ˜2.2 g/cm³ respectively. Conventional lightweight core materials have physical and chemical properties that are dissimilar to the elastomer matrix. The core material is intended to provide a substrate for the metal coating and does not in itself need to be conductive for the utility of the conductive rubber. Conventional conductive rubber is thus composed of three dissimilar components; the elastomer matrix, the conductive coating material, and the core material. As a third “spectator” component of the conductive rubber, conventional core materials have a disadvantage of providing a potential source of galvanic corrosion (as may encountered for graphite) or contamination that may compromise the function of the conductive rubber. As a result of practicing this invention, there is provided a conductive polymer that consists of only two dissimilar components; an elastomer matrix with an elastomer core material, and a conductive metal coating material. The elastomer core material may be identical in composition to the elastomer matrix, or may be composed of a different elastomer.

The conductive material is comprised of the conductive elastomer filler incorporated in an elastomer matrix to provide a thin conductive network of metal uniformly distributed throughout the matrix, thereby providing a conductive filler that has a low particle density compared to conventional lightweight conductive fillers. Low density conductive fillers are sought for applications in light-weight materials and for reducing cost.

The method of the invention for providing EMI shielding for application to a substrate comprises the steps of forming a composite of an elastomer polymer matrix and a particulate filler uniformly dispersed in the elastomer polymer matrix, said particulate filler consisting essentially of an elastomer polymer core having a metal coating encapsulating said core. The elastomer polymer core and the elastomer polymer matrix consist of any single, or combination of natural or syntheric elastomers. The metal is selected from the group consisting of nickel, copper, aluminum, tin, cobalt, zinc, Ag, Au, Pt, Pd, Ir and Rh and alloys thereof. The coating may consist of a single metal or a combination of metals. The preferred conductive metal coatings are nickel, or silver deposited on the nickel coating, or gold deposited on the nickel coating.

Advantageously, this invention provides a lightweight conductive rubber that consists only of elastomer and metal components that can be fabricated by processes that are already well known in the art. An additional advantage of this invention is in the wide selection of known elastomers that may be chosen as core materials. Such elastomers may be chosen, or tuned in formulation to provide specific physical and chemical properties to enhance utility. An example is the elastic property of the core imparting spring deflection to the thin metal cladding providing an enhancement or greater stability in intraparticle electrical contact. Unlike conventional core materials such as graphite and glass, elastomers are durable and are less likely to fracture during processing. In being polymers, elastomer core materials may be manufactured with a broad range of physical and chemical properties. For example, they may be loaded with functional additives such as corrosion inhibitors or be given specific surface properties that enhance metal-elastomer coupling.

### DESCRIPTION OF THE DRAWINGS

FIG. 1 is a cross-sectional view of the metal-coated elastomer polymer particles of the present invention incorporated in an elastomer polymer matrix.

### DESCRIPTION OF THE PREFERRED EMBODIMENT

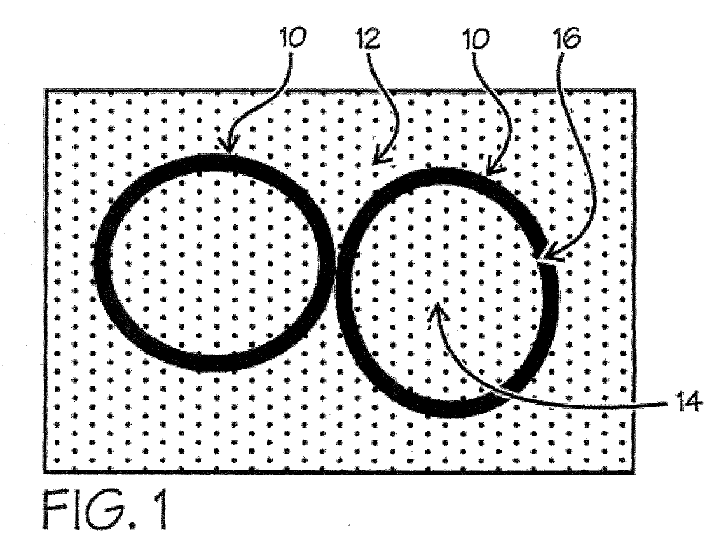

Having reference to the accompanying drawing, there is shown in FIG. 1 an embodiment of the conductive filler particles 10 of the present invention that are in physical contact with each other and uniformly dispersed in a polymer matrix 12 wherein the particulate elastomer polymer core 14 has a metal coating 16 encapsulating at least a portion of the core.

The inner core 14 may be formed of any suitable particulate elastomer polymer material such as natural rubber and synthetic elastomers including hydrocarbon rubbers (EPM, EPDM, butyl and the like), nitrites, polychloroprenes, acrylic, fluoro- and chlorosulfonated polyethylenes, polyurethanes, polyethers, polysulfides, nitrosorubbers, silicones and fluorosilicones and acrylics and mixtures thereof having an average size in the range of about 1 to 300 microns, preferably about 20 to 200 microns.

The metal coating 16 maybe selected from nickel, copper, aluminum, tin, cobalt, zinc, gold, silver, platinum, palladium, rhodium, iridium or their alloys and encapsulates the inner core in an amount which is necessary to provide conductivity in the composition. A metal coating in the amount of about 20 to 90 wt % of the coated particle, preferably about 30 to 80 wt %, has been found suitable to provide desired conductivity. The amount of metal coated will depend largely on particle size; if the particles are fine in size, e.g. in the 1-5 micron size range, the metal coating may comprise about 90-80 wt % on the fine polymer core. If the particles are coarse, e.g. about 100-300 microns in size, the metal layer may comprise about 30-20 wt % on the coarse polymer core. The polymer matrix includes natural and synthetic elastomers, and may be the same as the elastomer polymer of the inner core, namely natural rubber and synthetic elastomers including hydrocarbon rubbers (EPM, EPDM, butyl and the like), nitrites, polychloroprenes, acrylic, fluoro- and chlorosulfonated polyethylenes, polymethanes, polyethers, polysulfides, nitrosorubbers, silicones and fluorosilicones and acrylics and mixtures thereof.

In the embodiment illustrated in FIG. 1, the inner core is silicone elastomer powder 9506™ by Dow Corning and the metal is nickel. The nickel coating 16 is applied to the core 14 using conventional techniques well-known in the art such as electroless plating or hydrometallurgy, preferably to provide continuous encapsulation of the core. The metal coating such as nickel or silver is functional to provide bulk conductivity from particle to particle. Although it is preferred to completely encapsulate the core with the metal, it will be understood that desired conductivity or EMI shielding effectiveness may be attained with partial cladding of the core by the metal.

The particulate conductive filler of the invention is present in an amount up to 85 wt %, preferably about 30 to 80 wt %, of the composite material, depending on the size of the coated particles. Coarse particles in the 100-300 micron size range would comprise up to about 70-85 wt % of the composite material and particles in the 1-5 micron size range would comprise about 30 wt % of the composite materials. The particulate conductive material may be mixed with other particulate conductive fillers such as typified by silver-coated glass spheres to impart improved flow characteristics to the polymer matrix.

The particulate conductive filler and the composite material of the invention will now be described with reference to the following non-limitative examples.

### EXAMPLES

### Example I

Spherical silicone elastomer powder of particle size in the range of 1-5 microns (Dow Corning 9506™) was clad by hydrometallurgy with nickel to produce a conductive powder 80% by weight nickel.

The nickel coated silicone rubber powder produced was compounded with silicone resin to 63.5% by weight loading. The compound material was molded and cured into a sheet. The volume resistivity of the cured rubber was measured with 4-point resistance probe (Keithely™ model 580 micro-ohmmeter) with electrodes spaced 2.54 cm apart. The calculation of volume resistivity accounted for the volume of rubber between the two electrodes that were pressed on the rubber surfaces. Volume resistivity was measured to be 68.4 mΩ-cm. A second method for measuring volume resistivity consisted of a 1 cm diameter disc between two electrodes connected to a 4-point resistance probe (Keithely™ model 580 micro-ohmmeter). Volume resistivity-measured by his second method was 21.8 mΩ-cm.

The present invention provides a number of advantages. Core materials that are similar to the elastomer matrix in terms of physical and chemical properties are used rather than conventional, denser core materials, such as pure nickel, aluminum, glass or graphite. Elastomers such as silicone are significantly less dense (˜1 g/cm³) than graphite (˜2.2 g/cm³) or solid glass (˜2.5 g/cm³). Used as core materials, elastomers have the advantage of being durable, resilient, inexpensive, non-corrosive and offer a wide range of physical and chemical properties that are readily variable. Prior art conductive elastomers contain conductive fillers with core materials such as glass, graphite or aluminum that are not in themselves in the function of the conductive material. Use of such spectator can contribute to complications such as contamination, incompatibility or corrosion. In this invention, elastomers are used as the matrix and core materials thus producing a conductive rubber with a metal network as a single second component.

It will be understood, of course, that modifications can be made in the embodiments of the invention described herein without departing from the scope and purview of the invention as defined by the appended claims.

We claim:

1. A composite material comprising; an elastomer polymer matrix having a filler therein of particles formed of an elastomer polymer core, with a conductive metal coating thereon.

2. A composite material as claimed in claim 1 wherein said elastomer polymer matrix is selected from the group consisting of natural rubbers and synthetic rubbers including hydrocarbon rubbers (EPM, EPDM and butyl), nitrites, polychloroprenes, acrylic, fluoro- and chlorosulfonated polyethylenes, polyurethanes, polyethers, polysulfides, nitrosorubbers, silicones and fluorosilicones.

3. A composite material as claimed in claim 2 wherein said particulate elastomer core is selected from the group consisting of natural rubbers and synthetic rubbers including hydrocarbon rubbers (EPM, EPDM and butyl), nitrites, polychloroprenes, acrylic, fluoro- and chlorosulfonated polyethylenes, polyurethanes, polyethers, polysulfides, nitrosorubbers, silicones and fluorosilicones.

4. A composite material as claimed in claim 1 wherein said elastomer polymer matrix is silicone elastomer and said particulate elastomer core is silicone elastomer.

5. A composite material as claimed in claim 3 wherein said conductive metal coating is selected from the group consisting of nickel, copper, aluminum, tin, cobalt, zinc, gold, silver, platinum, palladium, rhodium, iridium and their alloys and combinations thereof.

6. A composite material as claimed in claim 5 wherein the particulate elastomer core is between about 1 and 300 microns in size.

7. A composite material as claimed in claim 5 wherein the particulate elastomer core is between about 20 and 200 microns in size.

8. A composite material as claimed in claim 5 wherein the conductive metal coating comprises about 20 to 90 wt % of the coated particle.

9. A composite material as claimed in claim 5 wherein the conductive metal coating comprises about 30 to 80 wt % of the coated particle.

10. A composite material as claimed in claim 8 in which the coated particulate elastomer core comprises about 30 to 80 wt % of the composite material.

11. A composite material as claimed in claim 3 in which the conductive metal coating is nickel, silver deposited on nickel, or gold deposited on nickel.

12. A composite material as claimed in claim 4 in which the conductive metal coating is nickel, silver deposited on nickel or gold deposited on nickel.

13. A method of providing EMI shielding for application to a substrate comprising the steps of forming a composite of an elastomer polymer matrix and a particulate filler uniformly dispersed in the elastomer polymer matrix, said particulate filler consisting essentially of an elastomer polymer core having a metal coating encapsulating said core.

14. A method as claimed in claim 13 wherein said central elastomer polymer core is selected from the group consisting of natural rubbers and synthetic rubbers including hydrocarbon rubbers (EPM, EPDM, butyl and the like), nitrites, polychloroprenes, acrylic, fluoro- and chlorosulfonated polyethylenes, polyurethanes, polyethers, polysulfides, nitrosorubbers, silicones and fluorosilicones.

15. A method as claimed in claim 14 wherein said elastomer polymer matrix is selected from the group consisting natural rubbers and synthetic rubbers including hydrocarbon rubbers (EPM, EPDM, butyl and the like), nitrites, polychloroprenes, acrylic, fluoro- and chlorosulfonated polyethylenes, polyurethanes, polyethers, polysulfides, nitrosorubbers, silicones and fluorosilicones.

16. A method as claimed in claim 14 wherein said metal is selected from the group consisting of nickel, copper, aluminum, tin, cobalt, zinc, Ag, Au, Pt, Pd, Ir and Rh and alloys thereof.

17. A method as claimed in claim 13 wherein the metal is nickel, silver deposited on nickel or gold deposited on nickel and the particulate elastomer polymer core and the elastomer polymer matrix are the same.

18. A method as claimed in claim 17 in which the elastomer polymer is silicone elastomer.

19. A method as claimed in claim 15 in which the conductive metal is nickel, silver deposited on nickel or gold deposited on nickel.
